(19) United States
(12) Patent Application Publication
(10) Pub. No.: US 2014/0053065 A1
(43) Pub. Date: Feb. 20, 2014

(54) SYSTEM AND METHOD FOR ADJUSTING WEBSITE DISPLAYS

(71) Applicants: Wesley J. Yun, San Francisco, CA (US); William S. Hede, Lake in the Hills, IL (US)

(72) Inventors: Wesley J. Yun, San Francisco, CA (US); William S. Hede, Lake in the Hills, IL (US)

(73) Assignee: MOTOROLA MOBILITY LLC, Libertyville, IL (US)

(21) Appl. No.: 13/587,289

(22) Filed: Aug. 16, 2012

(51) Int. Cl. G06F 17/00

(52) U.S. Cl. 715/238

(57) ABSTRACT

To ensure address a problem in displaying websites in resizable display regions, an example system monitors an active browser display region to determine if the display region satisfies a predetermined size condition, such as one or more of its dimensions being less than a predetermined threshold. If the display region satisfies the size condition, the example system automatically reloads the display region with an alternative version of its website, for example a mobile version of the website, enabling the user to more effectively read or navigate the displayed website.

### TECHNICAL FIELD

Various embodiments in the present disclosure concern web browsers and the handling of multiple web pages within a single browser window.

### BACKGROUND

In recent years, browsing the Internet, or more particularly the World Wide Web, have become commonplace for a significant portion of the world not only via browser-equipped desktop, laptop, and tablet computers, but also via mobile telephones. Indeed, it's the norm these days for browsers to enable browsing of multiple websites using a tabbed style interface, which allows one webpage per tab.

More recently, some browsers, such as Google Chrome and Firefox, accept extension software, known as plug-ins, that enable a user to split, or divide, a tab, which has been traditionally limited to display of a single website, into two separate panels, and thus view two websites side by side within the divided tab. This functionality is particularly useful for comparing search results from two different search engines, for comparing search results from the same search engine using slightly different queries, for dragging content from one website into another, or for reading or watching one website while blogging, chatting, or tweeting in another.

In these advanced browsers, it is also possible to laterally move a middle bar between the two side-by-side panels to widen one panel and simultaneously narrow the other. In some instances, moving the middle bar proportionally upsizes one website display and downsizes the other website display.

One problem with this resizing functionality is that users may downsize one panel to such a degree that reading or navigating the website it displays becomes impractical. In this case, the value of the dual-view display mode is completely undermined.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an example system corresponding to one or more embodiments.

FIG. 2 is a flow chart of an example method of operating a system, such as that shown in FIG. 1, and therefore corresponds to one or more embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

This document, which incorporates the drawings and the appended claims, describes one or more specific embodiments of one or more inventions. These embodiments, offered not to limit but only to exemplify and teach the invention, are shown and described in sufficient detail to enable those skilled in the art to implement or practice the invention(s). Thus, where appropriate to avoid obscuring the invention(s), the description may omit certain information known to those of skill in the art.

### OVERVIEW

To ensure that browser windows remain useful during resizing, the present inventors devised, among other things, one or more example systems, methods, and software that which provide alternatives to conventional resizing techniques for browser displays. One example system monitors an active browser display region to determine if the display region satisfies a predetermined size condition, such as one or more of its dimensions falls below a predetermined threshold. If the display region satisfies the size condition, the example system reloads the display region with an alternative version of its website, for example a mobile version of the website, enabling the user to more effectively read or navigate the displayed website.

In some embodiments, the active browser display region is one side or portion of a split browser window that displays two websites side by side. In still other embodiments, the browser display region is part of a divided application window that includes a non-browser application display region next to the browser display region. In yet other embodiments, the browser display region is dynamically and generally adjustable in response to changes in dimension of at least one other application display region, and the system reloads an alternative version of the website when the browser display region becomes too small.

### Example System Embodiment(s)

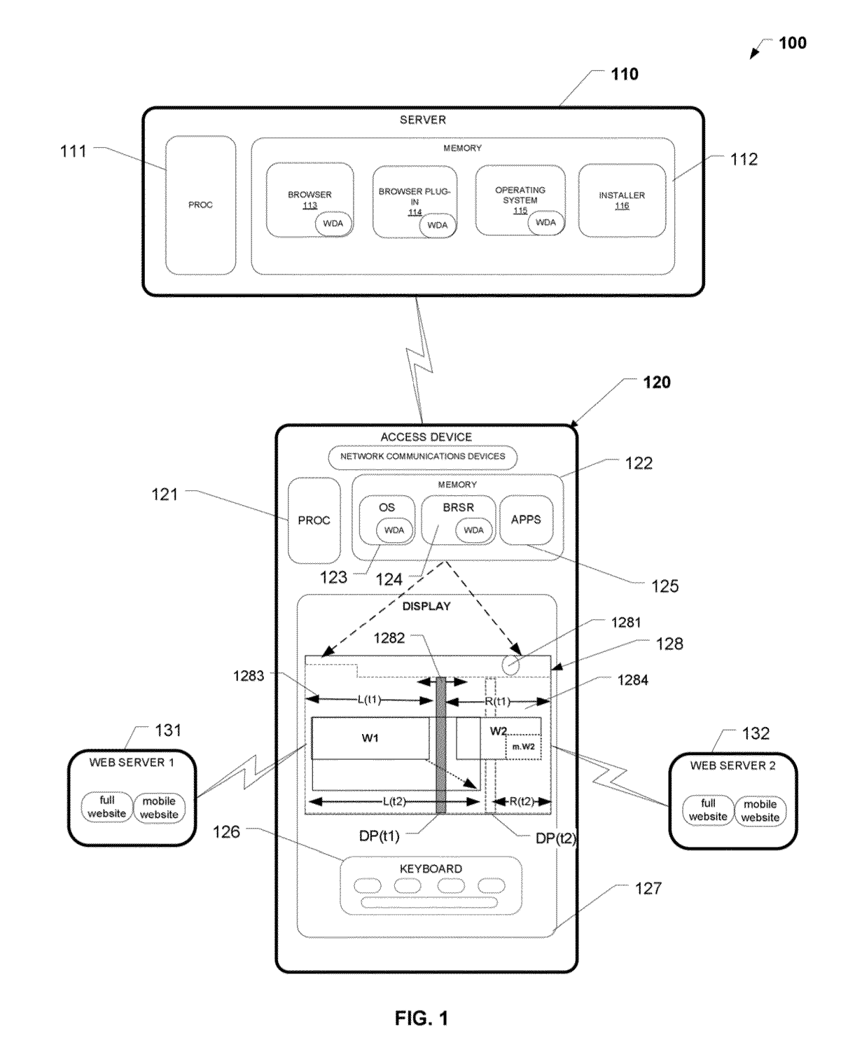

FIG. 1 shows an example online communications system 100. System 100 includes one or more download servers 110, and one or more access devices 120, and one or more web servers 130.

### Example Server

Server 110, which is generally representative of one or more servers for serving and installing software (sets of machine-readable and/or executable instructions sets) onto access devices. More particularly, server 110 includes a processor module 111, a memory module 112, a browser module 113, a browser plug-in module 114, an operating system module 115, and a software installer module 116.

Processor module 111 includes one or more local or distributed processors, controllers, or virtual machines. In the example embodiment, processor module 111 assumes any convenient or desirable form.

Memory module 112, which takes the example form of one or more electronic, magnetic, or optical data-storage devices, stores browser module 113, browser plug-in module 114, and operating system module 115, and software installer module 116.

Browser plug-in module 112 includes a set of one or more website display adjustment (WDA) plug-in modules (machine readable and/or executable instructions sets) for extending or augmenting the functionality of one or more browser applications (such as Microsoft Internet Explorer browser, Mozilla Firefox browser, Google Chrome browser, and Apple Safari browser) to enable dynamic adjustment of website display content by replacing a given currently displayed website page with one from a mobile domain associated with the same site (that is a .m version) or by re-rendering it using a mobile style sheet associated with the same site, when the display region is determined to be too small, for example one of its dimension is less than a predetermined length or its total area is less than a predetermined area. In some embodiments, the predetermined length or area is a function of display dimensions of the device running the browser.

In some embodiments, the browser-plug-in module enables splitting of an active browser display window into two side-by-side left and right panels separated by a movable divider bar, with one panel, for example the left panel displaying the website being viewed at the time of invoking the split, and the other panel displaying a website in accord with a Uniform Resource Locator (URL) entered or otherwise indicated by a user upon prompting.

The divider bar is movable laterally or horizontally via conventional mouse or touch operations to change the size of the left and right panels. The WDA plug-in, in some embodiments, continually monitors or waits for a change in position of the divider bar, and upon detecting a change, calculates a quantity indicative or representative of the absolute or relative dimensions of one or both of the panels. In some instances, the quantity is a ratio of the left panel width to the right panel width or a ratio of the total left panel area to the right panel area. The computed quantity is then compared to a predetermined threshold to determine whether to request a mobile version of the website in the smaller of the two panels. (Note that some embodiments monitor the size of the entire split window and replace both websites with their mobile versions upon detecting that the window is too small relative to a predetermined sizing standard.)

Browser module 114 includes machine readable and/or executable instruction sets and related data for providing browser functionality to a computing device, with the browser functionality including one o more aspects of the WDA functionality described above. In the example embodiment, the browser module includes one or more various forms of browser applications, such as Microsoft Internet Explorer, Firefox browser, Google Chrome, and Apple Safari, each of which includes a version of the WDA module.

Operating system (OS) module 115 include machine readable and/or executable instructions sets and related data for providing a platform on top of which other programs, called application programs, such as browsers, word processors, etc. can operate. In addition to this conventional functionality, operating system module 115 includes one or more aspects of the WDA functionality as described above, which is then accessible to any application that provide a browser display region.

Software installer module 115 includes machine executable and/or readable instructions and related data for facilitating download and installation of one or more instances of browser plug-in 113, browser module 114, or operating system module 115 over a wired or wireless local- or wide-area-network connection to one or more access devices, of which access device 120 is generally representative.

### Example Access Device

Access device 120 is generally representative of one or more access devices. In the example embodiment, access device 120 takes the form of a personal computer, desktop computer, laptop computer, tablet computer, workstation, personal digital assistant, smart phone, mobile telephone, or any other device having a display capability and a capability of communicating over a local- or wide-area network. Specifically, access device 120 includes a processor module 121, a memory module 122, an operating system 123, a browser module 124, an applications module 125, a keyboard 126, a display 127, a graphical user interface (GUI) 128, and a graphical pointer or selector 129.

Processor module 121 includes one or more processors, processing circuits, or controllers. In the example embodiment, processor module 121 takes any convenient or desirable form. Coupled to processor module 121 is memory 122.

Memory module 122 takes the example form of one or more electronic, magnetic, or optical data-storage devices stores code (machine-readable or executable instructions.) Specifically, memory module 122 stores code for operating system module 123, browser module 124, and applications module 125.

In the example embodiment, operating system module 123 takes the form of a version of one of the operating systems provided by server 110 and thus includes a WDA module. Browser module 124 takes the form of a version of one of the browsers provided by server 110 and thus natively includes or has been extended via a plug-in WDA module. Applications module 125 includes one or more non-browser applications, such as a word processing or blogging application or a social networking application, an email application, or presentation application. Operating system module 123 and browser module 124 not only receive inputs from keyboard 126 and selector 129, but also support rendering of GUI window 128 on display 127.

Upon rendering, GUI window 128 presents data in association with one or more interactive browser control features (or user-interface elements). In the example embodiment, GUI 128 follows a tabbed window format and includes a dual-view command feature 1281, which in response to being selected by a user invokes display of movable divider bar 1282 and division of GUI window 128 into left and right display panels 1283 and 1284. Left display panel 1283 displays a first website portion W1, which is hosted by web server 131, and right display panel 1284 displays a second website portion W2, which is hosted by web server 132.

Divider bar 1282 is shown at an initial position DP(t1), which sets the width dimension of left panel 1283 at L(t2) and the width dimension of right panel 1284 at R(t1). (In this embodiment, the height of the window is assumed constant; however, in general, it may also be varied, in which case, L(t1) and R(t1) can still be treated as a length quantity (for example, a diagonal display dimension) or as respectively representative of a total area of the left or right panels.) Divider bar 1282, which can be laterally moved to the left or right, is shown at a second position DP(t2).

Movement of the divider bar to this second position DP(t2) redefines the left panel 1283 to have a width dimension of L(t2) and the right panel 1284 to have a width dimension of R(t2). In this case, the WDA module portion of operating system or the browsers detects a change in the panel dimensions and determines whether the new size satisfies a predetermined size condition. If, for example the WDA module determines that panel 1284 is too small (relative to the left panel or to the display as a whole), it replaces website portion W2 with its mobile version m.W2. Further details regarding example operation of WDA module within the OS module or the browser module follow.

### Example Method(s) of Operation

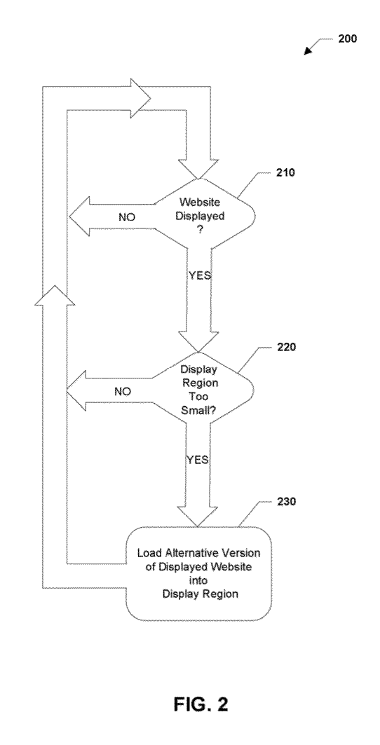

FIG. 2 shows a flow chart 200 of one or more example methods of operating a system, such as system 100. Flow chart 200 includes blocks 210-230, which are arranged and described in a serial execution sequence in the example embodiment. However, other embodiments execute two or more blocks in parallel using multiple processors or processor-like devices or a single processor organized as two or more virtual machines or sub processors. Other embodiments also alter the process sequence or provide different functional partitions to achieve analogous results. For example, some embodiments may alter the client-server allocation of functions, such that functions shown and described on the server side are implemented in whole or in part on the client side, and vice versa. Moreover, still other embodiments implement the blocks as two or more interconnected hardware modules with related control and data signals communicated between and through the modules. Thus, the example process flow applies to software, hardware, and firmware implementations.

At block 210, the example method begins with the example system, or more precisely WDA module, determining whether a website is being displayed within a display region of a display device, such as display 127 of access device 120. In general, if there is a website being displayed, it is displayed as a result of a browser application requesting a connection to a server associated with the website. The request entails providing a user-agent string or header to the server, identifying, among other things, the nature or type of the device hosting the browser application as well as the browser application and other information. If the determination is negative—that is, no website is being displayed—example execution branches back to block 210, and if the determination is affirmative, example execution continues at block 220.

Block 220 entails determining whether the display region displaying the website is too small. In the example embodiment, this determination entails comparing a quantity representative of or based on the size of the display region to a predetermined threshold. The quantity can be a width or height of the display region, or a total area of the display region, or a ratio of a display dimension or area to that of another display dimension or area. The predetermined threshold can also be a predetermined width, height, area, or ratio. In some cases, this width, height, area, or ratio is a function of the total display size. In some embodiments, such as the FIG. 1 system that provides a dual-view tabbed browser window, the display region for a given website is deemed too small, when the display area for one of the two displayed websites is less than or equal to a predetermined percentage, for example 30%, of the total display area of the browser window. (In some embodiments, the threshold or more generally predetermined size condition is a function of the type of content displayed in the smallest of the display regions. For example, if a photograph or map is the predominant content, then the threshold or condition may be relaxed to 20%; whereas if the content is predominantly text from a blog post or news article, the condition may be tightened to 40%. or 50%.) If the quantity is greater than or equal to the threshold, the display region is not deemed too small, and execution returns to block 210. On the other hand, if it is less than or equal to the threshold, the display region is deemed too small and execution continues at block 230. (Note that if there are multiple active display regions that display a website, the block 220 is repeated for each website display region.)

Block 230 entails replacing the currently displayed website in each display region that was deemed too small (or more generally as satisfying a predetermined size constraint or condition) with an alternative version of the displayed website. In the example embodiment, this replacement entails requesting a mobile version of the displayed website by adding a mobile prefix or suffix onto the URL for the website page being displayed or by requesting mobile style sheets. (In general, the first displayed website and the alternative version of the website will share a common domain name.)

In some embodiments, this replacement or reload process entails changing the user-agent string or header used by the browser application to indicate that the host access device is a mobile device or alternative device that would invoke the web server to serve the mobile website or similarly formatted web page. Other embodiments refer to a prestored listing of website URLs and corresponding mobile version URLs, enabling a direct request for the corresponding mobile version. And still other embodiments execute an Internet search for the corresponding mobile version of the website to be replaced. Some embodiments two or more of these approaches in sequence, for example, referencing a prestored table or listing, and if this approach is unsuccessful, altering the user-agent string, and if this approach is unsuccessful, finally conducting an Internet search for the desired website. If no mobile version is available, some embodiments display only the navigation bar of the website, while others may simply downscale the existing website to the available display area or leave the displayed website unchanged. Execution then returns to block 210.

### CONCLUSION

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms, such as second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may comprise one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, some embodiments can be implemented as a computer-readable storage medium having computer readable code stored thereon for programming a computer (e.g., comprising a processor) to perform a method as described and claimed herein. Likewise, computer-readable storage medium can comprise a non-transitory machine readable storage device, having stored thereon a computer program that include a plurality of code sections for performing operations, steps or a set of instructions.

Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

The claimed invention is:

1. A method comprising:
displaying at least a portion of a website within a display region of a display; and
in response to changing a size of the display region to satisfy a predetermined size condition, displaying an alternative version of the website within the display region.

2. The method of claim 1:
wherein displaying at least a portion of the website within the display region includes communicating a first user-agent string to a server hosting the website; and
wherein displaying the alternative version o the website the display region includes communicating a second user-agent string to the server, with the second user-agent string indicative of a different size display than the first user-agent string.

3. The method of claim 1, wherein the predetermined size condition is a function of content type displayed in the display region.

4. The method of claim 1:
wherein displaying at least a portion of the website within the display region includes displaying a portion of a non-mobile version of the website;
wherein changing the size of the display region to satisfy a predetermined size condition includes reducing the size of the display region; and
wherein displaying the alternative version of the website includes displaying at least a portion of a mobile version of the website.

5. The method of claim 1:
wherein displaying a least a portion of a website within the display region of a display includes displaying a mobile version of the website; and
wherein displaying the alternative version of the website includes displaying at least a portion of a non-mobile version of the website.

6. The method of claim 1, wherein displaying the alternative version of the website within the display region includes requesting mobile style sheets from a server.

7. The method of claim 1, wherein the website and the alternative version of the website have different uniform resource locators that share a common domain name.

8. The method of claim 1:
wherein displaying at least a portion of the website within the display region of the display, comprises displaying the portion of the website within one panel of an active browser window having first and second adjacent panels;
wherein displaying the alternative version of the website occurs in response to reducing the size of the one panel to satisfy a predetermined size condition; and
wherein displaying the alternative version of the website includes displaying at least a portion of a mobile version of the website.

9. The method of claim 8, wherein displaying the alternative version of the website occurs in response to user movement of a movable divider that redefines the first and second panel to satisfy the predetermined size condition.

10. The method of claim 8, wherein the predetermined size condition is a function of content type displayed in the one panel.

11. A system comprising:
a processor coupled to a memory and a display;
wherein the memory stores:
a first set of one or more instructions for causing display of a website within a display region of the display; and
a second set of one or more instructions responsive to changing a size of the display region to satisfy a predetermined size condition for causing display of an alternative version of the website within the display region.

12. The system of claim 11:
wherein the first set of instructions for displaying at least a portion of the website within the display region includes a set of one or more instructions for communicating a first user-agent string to a server hosting the website; and
wherein the second set of instructions includes a set of one or more instructions for communicating a second user-agent string to the server, with the second user-agent string indicative of a different size display than the first user-agent string.

13. The system of claim 11, wherein the predetermined size condition is a function of content type displayed in the display region.

14. The system of claim 11:
wherein displaying at least a portion of the website within the display region includes displaying a portion of one of a non-mobile version of the website and a mobile version of the website; and
wherein displaying the alternative version of the website includes displaying at least a portion of the other of the non-mobile version of the website and the mobile version of the website.

15. The system of claim 11, wherein the second set of one or more instructions for causing display of the alternative version of the website within the display region include instructions for causing a request of mobile style sheets for the website from a server.

16. The system of claim 11, wherein the website and the alternative version of the website have different uniform resource locators that share a common domain name.

17. A system comprising:
means for communicating via a communications network with one or more web servers;
a display for displaying content from one or more of the web servers;
means for causing display of at least a portion of a website hosted by one of the web servers within a display region of the display; and
means, responsive to changing size of the display region to satisfy a predetermined size condition, for causing display of an alternative version of the website within the display region.

18. The system of claim 17:
wherein the means for causing display of at least a portion of the website within the display region includes means for communicating a first user-agent string to the one of the servers hosting the website; and
wherein the means for causing display of the alternative version o the website the display region includes means for communicating a second user-agent string to the one of the servers hosting the website, with the second user-agent string indicative of a different size display than the first user-agent string.

19. The system of claim 18, wherein the predetermined size condition is a function of content type displayed in the display region.

20. A non-transient machine-readable medium storing:
a first set of one or more instructions for causing display of at least a portion of a website within a display region of a display; and
a second set of one or more instructions, responsive to changing size of the display region to satisfy a predetermined size condition, for causing display of an alternative version of the website within the display region.

21. The non-transient machine-readable medium of claim 20:
wherein the first set of instructions for displaying at least a portion of the website within the display region includes a set of one or more instructions for communicating a first user-agent string to a server hosting the website; and
wherein the second set of instructions includes a set of one or more instructions for communicating a second user-agent string to the server, with the second user-agent string indicative of a different size display than the first user-agent string.

22. The non-transient machine-readable medium of claim 20, wherein the predetermined size condition is a function of content type displayed in the display region.

23. A method comprising:
communicating a first user-agent string to a server as part of a request to receive at least a portion of a website hosted by the server;
adjusting a size of a browser display region displaying at least a portion of the website;
in response to resizing the browser display region, automatically communicating a second user-agent string to the server as part of a request to receive at least a portion of the website, wherein the second user-agent string is indicative of a device having a different display size than that indicated in the first user-agent string.

24. The method of claim 23, wherein automatically communicating the second user-agent string occurs in response to the browser display region being determined to satisfy a predetermined size condition.

25. The method of claim 24, wherein the predetermined size condition is a function of type of content displayed in the browser display region.
